(19) United States
(12) Patent Application Publication
(10) Pub. No.: US 2025/0183268 A1
(43) Pub. Date: Jun. 5, 2025

(54) POWER STORAGE CELL AND METHOD OF MANUFACTURING ELECTRODE COMPOSITE MATERIAL LAYER

(71) Applicant: TOYOTA JIDOSHA KABUSHIKI KAISHA, Toyota-shi (JP)

(72) Inventor: Shinichiro ITO, Kosai-shi (JP)

(73) Assignee: TOYOTA JIDOSHA KABUSHIKI KAISHA, Toyota-shi (JP)

(21) Appl. No.: 18/911,573

(22) Filed: Oct. 10, 2024

(30) Foreign Application Priority Data
Dec. 5, 2023 (JP) 2023-205383

(51) Int. Cl. H01M 4/36; H01M 4/02; H01M 4/04

(52) U.S. Cl. CPC H01M 4/364; H01M 4/0404; H01M 4/0435; H01M 2004/021

(57) ABSTRACT

A power storage cell in which an electrolyte solution is used includes: a first electrode composite material layer; a separator; and a second electrode composite material layer facing the first electrode composite material layer with the separator interposed therebetween. The first electrode composite material layer includes a first reference density portion and a first high-density portion higher in density than the first reference density portion. The first high-density portion is provided to divide the first reference density portion into two or more and surround each of the first reference density portions.

### CROSS REFERENCE TO RELATED APPLICATIONS

This nonprovisional application is based on Japanese Patent Application No. 2023-205383 filed on Dec. 5, 2023 with the Japan Patent Office, the entire contents of which are hereby incorporated by reference.

### BACKGROUND

### Field

The present disclosure relates to a power storage cell.

### Description of the Background Art

As a conventional power storage cell, Japanese Patent Laying-Open No. 2016-100278 discloses a technique of suppressing an increase in internal resistance by providing first and second electrodes in which the coefficient of permeability is smaller in their outer edge portions than in their central portions.

### SUMMARY

When a composite material layer expands and contracts during charging and discharging, an electrolyte solution is pushed out from the central portion of each of the first and second electrodes to the outside thereof. As the first and second electrodes are larger in area, the distance over which the electrolyte solution pushed out to the outside returns to a central portion of each of their composite material layers becomes longer. Thereby, the electrolyte solution pushed out to the outside less easily returns to the central portion of each composite material layer, which leads to a concern that the amount of liquid retention in the central portion may decrease.

The present disclosure has been made in view of the above-described problems, and an object thereof is to provide a power storage cell and a method of manufacturing an electrode composite material layer, by which the liquid retention property can be enhanced. A power storage cell according to the present disclosure is a cell in which an electrolyte solution is used. The power storage cell includes: a first electrode composite material layer; a separator; and a second electrode composite material layer facing the first electrode composite material layer with the separator interposed therebetween. The first electrode composite material layer includes: a first reference density portion; and a first high-density portion higher in density than the first reference density portion. The first high-density portion is provided to divide the first reference density portion into two or more and surround each of the first reference density portions.

According to the above-described configuration, the first high-density portion divides the first reference density portion of the first electrode composite material layer into two or more and surrounds each of the first reference density portions. Thereby, the electrolyte solution can be suppressed from being pushed out from each of the divided first reference density portions to the outside of the first electrode composite material layer.

Further, as compared with the configuration in which an outer edge of a single first reference density portion is surrounded by the first high-density portion, it is possible to reduce the distance from the first high-density portion surrounding each of the divided first reference density portions to the central portion in each of the divided first reference density portions. Thus, even when the first electrode composite material layer is increased in area, the electrolyte solution pushed out to the outside of the first electrode composite material layer easily returns to the central portion in each of the divided first reference density portions, so that the liquid retention property can be enhanced.

In the power storage cell according to the present disclosure, the second electrode composite material layer may include: a second reference density portion; and a second high-density portion higher in density than the second reference density portion. The second high-density portion may be provided to surround the second reference density portion. The first reference density portion surrounded by the first high-density portion may be disposed to face at least a part of the second reference density portion surrounded by the second high-density portion, with the separator being interposed between the first reference density portion and the part of the second reference density portion.

According to the above-described configuration, the first electrode composite material layer includes the first high-density portion and the second electrode composite material layer also includes the second high-density portion. Thereby, also on the second electrode composite material layer side, the electrolyte solution can be suppressed from being pushed out to the outside of the second electrode composite material layer.

In the power storage cell according to the present disclosure, the second high-density portion may be provided to divide the second reference density portion into two or more and surround each of the second reference density portions. In this case, when viewed in a stacking direction in which the first electrode composite material layer and the second electrode composite material layer are stacked, each of the first reference density portions each surrounded by the first high-density portion may overlap with each of the second reference density portions each surrounded by the second high-density portion.

According to the above-described configuration, the capacity sustaining effect (dischargeable state of charge (SOC)) can be enhanced while enhancing the liquid retention property in each of the first electrode composite material layer and the second electrode composite material layer.

In the power storage cell according to the present disclosure, the first high-density portion may be higher in density than the first reference density portion by 10% or more.

According to the above-described configuration, the capacity sustaining effect can be enhanced.

In the power storage cell according to the present disclosure, a relation of 9≤B×C<199 may be satisfied, where B (%) represents a proportion of an area of the first reference density portion surrounded by the first high-density portion in an area of the first electrode composite material layer, and C represents an average discharge rate during discharging.

According to the above-described configuration, the capacity sustaining effect can be enhanced.

In the power storage cell according to the present disclosure, a relation between the B and the C may satisfy 17≤B×C<99.

According to the above-described configuration, the capacity sustaining effect can be further enhanced.

In the power storage cell according to the present disclosure, the first high-density portion may be thicker than the first reference density portion.

According to the above-described configuration, the first high-density portion is increased in thickness and thereby enhanced in function as a wall, so that the electrolyte solution is less easily discharged to the outside of the first electrode composite material layer.

In the power storage cell according to the present disclosure, each of the first reference density portions divided by the first high-density portion may have an area of 600 cm² or more.

In general, as the electrode composite material layer is larger in area, dry-up is more likely to occur. According to the above-described configuration, even when the area of the first reference density portion is equal to or greater than the above-described value, the above-mentioned first high-density portion is provided to thereby enhance the liquid retention property, so that dry-up is less likely to occur. This makes it possible to suppress a decrease in capacity.

A method of manufacturing an electrode composite material layer according to the present disclosure includes: disposing a frame member on a current collector and coating an inside of the frame member with an electrode slurry; forming a reference film thickness portion and a thick film portion thicker than the reference film thickness portion on the electrode slurry applied by the coating; and pressing the electrode slurry on which the thick film portion is formed. In the forming a thick film portion, the thick film portion is formed to divide the reference film thickness portion into two or more and surround each of the reference film thickness portions. In the pressing, a reference density portion is formed in a portion where the reference film thickness portion is formed, and a high-density portion higher in density than the reference density portion is formed in a portion where the thick film portion is formed.

According to the above-described configuration, it is possible to manufacture the electrode composite material layer in which the reference density portion is divided into two or more and the high-density portion surrounds each of the reference density portions. By using this electrode composite material layer, the liquid retention property can be enhanced in the same way as described above.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a schematic plan view of a power storage cell according to a first embodiment.

FIG. 2 is a schematic cross-sectional view taken along a line II-II shown in FIG. 1.

FIG. 3 is a schematic plan view of a second electrode of the power storage cell according to the first embodiment.

FIG. 4 is a schematic plan view of a first electrode of the power storage cell according to the first embodiment.

FIG. 5 is a schematic plan view showing a positional relation between the second electrode and the first electrode of the power storage cell according to the first embodiment.

FIG. 6 is a schematic diagram showing a first step in manufacturing a second electrode composite material layer according to the first embodiment.

FIG. 7 is a schematic diagram showing a second step in manufacturing the second electrode composite material layer according to the first embodiment.

FIG. 8 is a schematic diagram showing a third step in manufacturing the second electrode composite material layer according to the first embodiment.

FIG. 9 is a schematic diagram showing a fourth step in manufacturing the second electrode composite material layer according to the first embodiment.

FIG. 10 is a schematic plan view showing a positional relation between a second electrode and a first electrode of a power storage cell according to a second embodiment.

FIG. 11 is a schematic plan view showing a positional relation between a second electrode and a first electrode of a power storage cell according to a third embodiment.

FIG. 12 is a schematic plan view showing a positional relation between a second electrode and a first electrode of a power storage cell according to a fourth embodiment.

FIG. 13 is a diagram showing conditions and results of a first verification experiment.

FIG. 14 is a diagram showing conditions and results of a second verification experiment.

### DESCRIPTION OF THE PREFERRED EMBODIMENTS

Hereinafter, embodiments of the present disclosure will be described in detail with reference to the accompanying drawings. In the embodiments described below, the same or corresponding portions are denoted by the same reference characters in the drawings, and the description thereof will not be repeated.

### First Embodiment

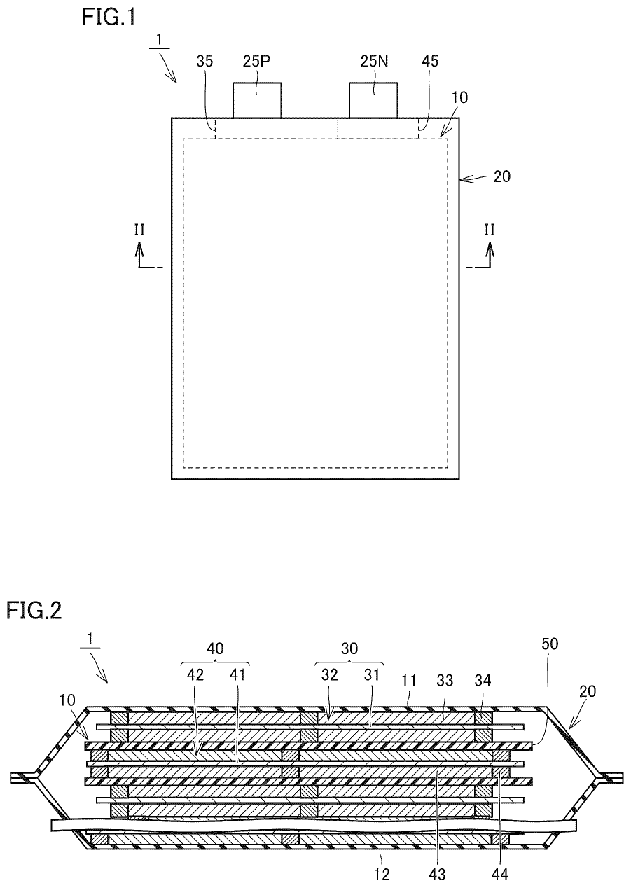

FIG. 1 is a schematic plan view of a power storage cell according to the first embodiment. FIG. 2 is a schematic cross-sectional view taken along a line II-II shown in FIG. 1. A power storage cell 1 according to the first embodiment will be hereinafter described with reference to FIGS. 1 and 2.

Power storage cell 1 according to the first embodiment is for driving a vehicle and is mounted, for example, on: a hybrid electric vehicle powered by an internal combustion engine such as a gasoline engine or a diesel engine and by a motor receiving electric power from a chargeable/dischargeable battery; a plug-in hybrid electric vehicle that is externally chargeable; a battery electric vehicle; and the like.

The first embodiment will be described with reference to an example in which power storage cell 1 is a laminate-type liquid-type battery, but the present disclosure is not limited to the laminate type, and a rectangular tube-shaped liquid-type battery may be applicable. In other words, an exterior body 20 (described later) may be formed of a rectangular tube-shaped metal member.

As shown in FIGS. 1 and 2, power storage cell 1 according to the first embodiment includes an electrode body 10, exterior body 20, a first electrode terminal 25P, and a second electrode terminal 25N. For example, first electrode terminal 25P is a positive electrode terminal, and second electrode terminal 25N is a negative electrode terminal.

Exterior body 20 accommodates electrode body 10 and an electrolyte solution. Exterior body 20 is formed of a laminate, for example. The electrolyte solution contains, for example, a non-aqueous solvent and a supporting salt such as lithium salt that generates a charge carrier.

Electrode body 10 is what is called a stacked-type electrode body and includes a plurality of first electrodes 30, a plurality of second electrodes 40, and a plurality of separators 50. For example, first electrode 30 is a positive electrode and second electrode 40 is a negative electrode. Electrode body 10 is configured by stacking first electrode 30 and second electrode 40 with separator 50 interposed therebetween. Note that the number of first electrodes 30 should only be one or more and the number of second electrodes 40 should only be one or more.

Each first electrode 30 includes a first electrode current collector 31 and a first electrode composite material layer 32. First electrode current collector 31 is provided in a sheet shape. First electrode current collector 31 is a positive electrode current collector. First electrode current collector 31 includes a rectangular main body and a first electrode tab 35 protruding from one side of the main body.

First electrode tabs 35 are disposed to overlap with each other when viewed in a stacking direction in which first electrode 30 and second electrode 40 are stacked. Each first electrode tab 35 is connected to first electrode terminal 25P.

First electrode current collector 31 is formed, for example, of an aluminum foil or an aluminum alloy foil. First electrode composite material layer 32 is provided on the surface of first electrode current collector 31. More specifically, first electrode composite material layer 32 is provided on each of both surfaces of first electrode current collector 31 in the stacking direction. First electrode tab 35 is not provided with first electrode composite material layer 32. First electrode composite material layer 32 is a positive electrode composite material layer.

First electrode composite material layer 32 includes a first reference density portion 33 and a first high-density portion 34 higher in density than first reference density portion 33. First high-density portion 34 is higher in density than first reference density portion 33, for example, by 10% or more. First high-density portion 34 may be equal in thickness to first reference density portion 33 or may be thicker than first reference density portion 33.

The area of a coating on first electrode composite material layer 32 is, for example, about 7000 cm², but is not limited thereto. The area of the coating on first electrode composite material layer 32 may be 600 cm² or more, 1000 cm² or more, 3000 cm² or more, 4000 cm² or more, 5000 cm² or more, 6000 cm² or more, 7000 cm² or more, 8000 cm² or more, or 10000 cm² or more. The area of the coating on first electrode composite material layer 32 may be 7000 cm² or less, 8000 cm² or less, 10000 cm² or less, or 12000 cm² or less. The area of the coating on first electrode composite material layer 32 may be 6500 cm² or more and 7500 cm² or less. Even when the area of the coating on first electrode composite material layer 32 is increased, the electrolyte solution pushed out to the outside of first electrode composite material layer 32 easily returns to the central portion in each of divided first reference density portions 33, so that the liquid retention property can be enhanced. Further, the basis weight of first electrode composite material layer 32 is, for example, about 30 mg/cm², but is not limited thereto. The basis weight of first electrode composite material layer 32 may be 20 mg/cm² or more, 30 mg/cm² or more, 40 mg/cm² or more, 50 mg/cm² or more, or 60 mg/cm² or more. The basis weight of first electrode composite material layer 32 may be 30 mg/cm² or less, 40 mg/cm² or less, or 50 mg/cm² or less.

First electrode composite material layer 32 contains a first electrode active material. The first electrode active material is, for example, a material capable of occluding and releasing lithium. Examples of the first electrode active material applicable herein are lithium cobalt oxide (LiCoO₂), lithium manganese oxide (LiMn₂O₄), lithium nickel oxide (LiNiO₂), and the like. Further, the first electrode active material may be a lithium transition metal composite oxide such as a lithium-nickel-cobalt-manganese composite oxide.

Each second electrode 40 includes a second electrode current collector 41 and a second electrode composite material layer 42. Second electrode current collector 41 is provided in a sheet shape. Second electrode current collector 41 has a rectangular main body and a second electrode tab 45 protruding from one side of the main body.

Second electrode tabs 45 are disposed to overlap with each other when viewed in the stacking direction in which first electrode 30 and second electrode 40 are stacked. Each second electrode tab 45 is connected to second electrode terminal 25N.

Second electrode current collector 41 is formed, for example, of a copper foil. Second electrode composite material layer 42 is provided on the surface of second electrode current collector 41. More specifically, second electrode composite material layer 42 is provided on each of both surfaces of second electrode current collector 41 in the above-mentioned stacking direction. Second electrode tab 45 is not provided with second electrode composite material layer 42. Second electrode composite material layer 42 is a negative electrode composite material layer.

Second electrode composite material layer 42 faces first electrode composite material layer 32 with separator 50 interposed therebetween. Second electrode composite material layer 42 includes a second reference density portion 43 and a second high-density portion 44 higher in density than second reference density portion 43. Second high-density portion 44 is higher in density than second reference density portion 43, for example, by 10% or more. Second high-density portion 44 may be equal in thickness to second reference density portion 43, or may be thicker than second reference density portion 43.

The area of a coating on second electrode composite material layer 42 is larger than the area of the coating on first electrode composite material layer 32. The area of the coating on second electrode composite material layer 42 is, for example, about 7050 cm², but is not limited thereto. The area of the coating on second electrode composite material layer 42 may be 600 cm² or more, 1000 cm² or more, 3000 cm² or more, 4000 cm² or more, 5000 cm² or more, 6000 cm² or more, 7000 cm² or more, 8000 cm² or more, 10000 cm² or more, or 12000 cm² or more. The area of the coating on second electrode composite material layer 42 may be 7000 cm² or less, 8000 cm² or less, 10000 cm² or less, or 12000 cm² or less. The area of the coating on second electrode composite material layer 42 may be 6500 cm² or more and 7500 cm² or less. Even when the area of the coating on second electrode composite material layer 42 is increased, the electrolyte solution pushed out to the outside of first electrode composite material layer 32 easily returns to the central portion in each of divided first reference density portions 33, so that the liquid retention property can be enhanced. The basis weight of second electrode composite material layer 42 is, for example, about 20 mg/cm², but is not limited thereto. The basis weight of second electrode composite material layer 42 may be 20 mg/cm² or more, 30 mg/cm² or more, 40 mg/cm² or more, or 50 mg/cm² or more. The basis weight of first electrode composite material layer 32 may be 30 mg/cm² or less, 40 mg/cm² or less, or 50 mg/cm² or less.

Second electrode composite material layer 42 contains a second electrode active material. The second electrode active material is, for example, a material capable of occluding and releasing lithium ions. An example of the second electrode active material applicable herein is a carbon material such as graphite.

Separator 50 is interposed between first electrode 30 and second electrode 40. Separator 50 insulates first electrode composite material layer 32 from second electrode composite material layer 42. As separator 50, for example, a sheet of resin such as polyethylene (PE) or polypropylene (PP) can be used.

First electrode terminal 25P has one end and the other end in a direction orthogonal to the stacking direction. One end side of first electrode terminal 25P is exposed from exterior body 20. The other end side of first electrode terminal 25P is located inside exterior body 20.

The other end side of first electrode terminal 25P is joined to first electrode tab 35. This joining may be done by resistance welding, laser welding, ultrasonic welding, or the like. First electrode terminal 25P is formed of a plate-shaped metal member. Specifically, first electrode terminal 25P is formed of an aluminum plate.

Second electrode terminal 25N has one end and the other end in a direction orthogonal to the stacking direction. One end side of second electrode terminal 25N is exposed from exterior body 20. The other end side of second electrode terminal 25N is located inside exterior body 20.

The other end side of second electrode terminal 25N is joined to second electrode tab 45 by welding or the like. This joining may be done by resistance welding, laser welding, ultrasonic welding, or the like. Second electrode terminal 25N is formed of a plate-shaped metal member. Specifically, second electrode terminal 25N is formed of a copper plate.

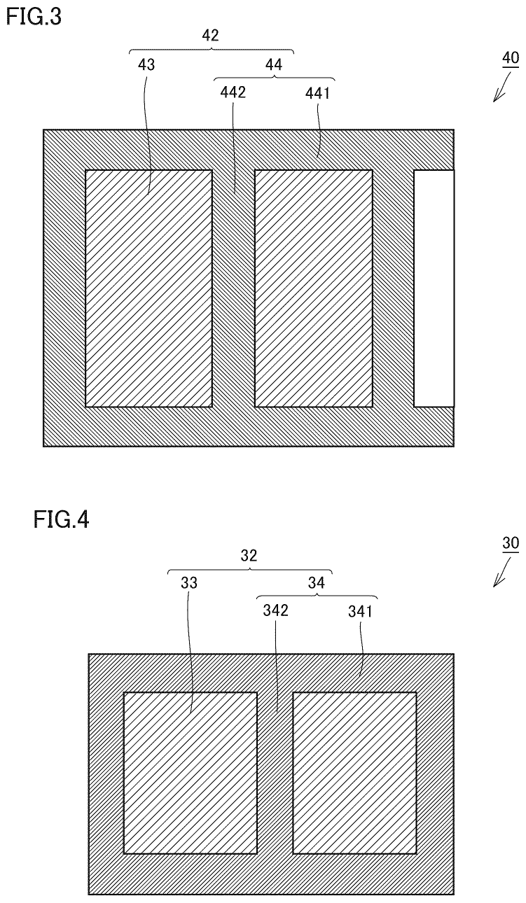

FIG. 3 is a schematic plan view of the second electrode of the power storage cell according to the first embodiment. Second electrode 40 will be hereinafter described in detail with reference to FIG. 3.

As shown in FIG. 3, second high-density portion 44 of second electrode 40 is provided to divide second reference density portion 43 into two and surround each of the divided second reference density portions 43. Second high-density portion 44 includes a frame-shaped portion 441 and a partition portion 442.

Frame-shaped portion 441 includes: a first portion extending along three sides of the above-mentioned main body of second electrode current collector 41; and a second portion located inside the remaining one side of the main body so as to extend along this remaining one side. The first portion has an angular U-shape, and the second portion is provided in a straight line shape. The second portion is located at a distance from the remaining one side of the main body. The second portion is configured such that the distance from the remaining one side of the main body to the second portion is longer than the distance from each of the three sides of the main body to the first portion. The distance from the remaining one side of the main body to the second portion is substantially equal to the width of first high-density portion 34 (described later). Second electrode composite material layer 42 is not provided between the second portion and the remaining one side.

Partition portion 442 is provided to divide a region surrounded by frame-shaped portion 441 into two regions. Second reference density portion 43 is provided in each of the two regions divided by partition portion 442. Partition portion 442 is provided in a straight line shape. Partition portion 442 is provided substantially in parallel to the second portion.

FIG. 4 is a schematic plan view of the first electrode of the power storage cell according to the first embodiment. First electrode 30 will be hereinafter described in detail with reference to FIG. 4.

As shown in FIG. 4, first high-density portion 34 of first electrode 30 is provided to divide first reference density portion 33 into two and surround each of these two first reference density portions 33. First high-density portion 34 includes a frame-shaped portion 341 and a partition portion 342.

Frame-shaped portion 341 is provided to extend along four sides of the main body of first electrode current collector 31. Frame-shaped portion 341 may be spaced apart from these four sides of the main body. Partition portion 342 is provided to divide a region surrounded by frame-shaped portion 341 into two regions. First reference density portion 33 is provided in each of the two regions divided by partition portion 342. Partition portion 342 is provided in a straight line shape.

FIG. 5 is a schematic plan view showing the positional relation between the second electrode and the first electrode of the power storage cell according to the first embodiment. As shown in FIG. 5, first high-density portion 34 is disposed adjacent to second high-density portion 44 when viewed in the stacking direction.

Specifically, when viewed in the stacking direction, frame-shaped portion 341 is adjacent to frame-shaped portion 441. More specifically, frame-shaped portion 341 includes: a portion adjacent to the first portion of frame-shaped portion 441 inside this first portion; and a portion adjacent to the second portion of frame-shaped portion 441 outside this second portion. When viewed in the stacking direction, partition portion 342 is adjacent to partition portion 442.

First reference density portion 33 surrounded by first high-density portion 34 is disposed so as to face at least a part of second reference density portion 43 surrounded by second high-density portion 44, with separator 50 being interposed between first reference density portion 33 and the part of second reference density portion 43.

In first reference density portion 33 located on one side in an arrangement direction in which first reference density portions 33 are arranged, a portion on one side in the arrangement direction faces second reference density portion 43 with separator 50 interposed therebetween, and a portion on the other side in the arrangement direction faces partition portion 442 with separator 50 interposed therebetween.

In first reference density portion 33 located on the other side in the arrangement direction, a portion on one side in the arrangement direction faces second reference density portion 43 with separator 50 interposed therebetween, and a portion on the other side in the arrangement direction faces the second portion of frame-shaped portion 441 with separator 50 interposed therebetween.

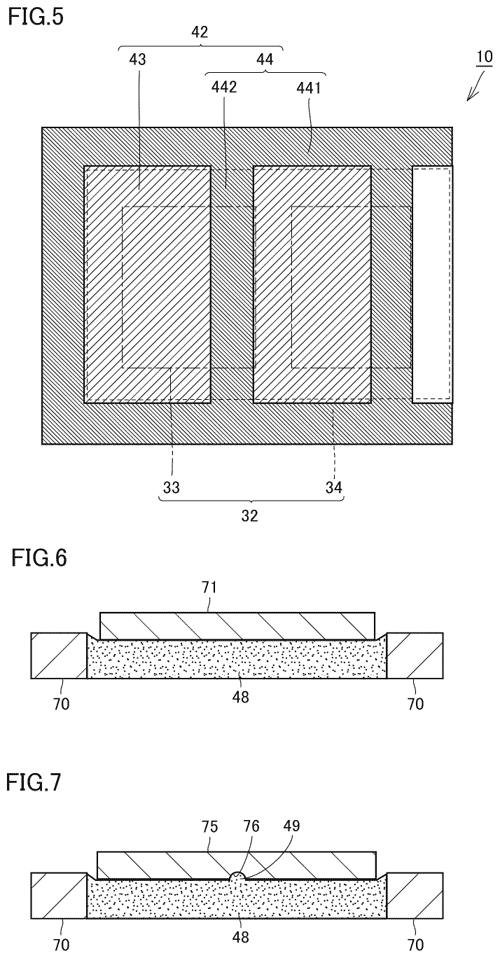

FIGS. 6 to 9 are schematic diagrams showing first to fourth steps in manufacturing the second electrode composite material layer according to the first embodiment. FIGS. 6 to 9 do not show second electrode current collector 41 for the sake of convenience. The following describes a method of manufacturing second electrode composite material layer 42 with reference to FIGS. 6 to 9, but a method of manufacturing first electrode composite material layer 32 will not be described since first electrode composite material layer 32 is manufactured in substantially the same manner as in the method of manufacturing second electrode composite material layer 42.

In manufacturing second electrode composite material layer 42, as shown in FIG. 6, a frame member 70 is first disposed on the surface of second electrode current collector 41, and then, a second electrode slurry 48 is coated on the inside of the frame member using a coating device. Second electrode slurry 48 applied by coating is spread by a first squeegee 71. First squeegee 71 has a flat portion that is brought into contact with second electrode slurry 48. When the viscosity of second electrode slurry 48 is about 10000 mPa·s, the outer edge portion of second electrode slurry 48 that contacts frame member 70 becomes thicker than the central portion thereof due to the surface tension.

Then, as shown in FIG. 7, the surface shape of second electrode slurry 48 is adjusted using a second squeegee 75. Second squeegee 75 has a notch 76 provided in a portion to be brought into contact with second electrode slurry 48. Notch 76 is provided to extend in the direction away from second electrode slurry 48 (to extend upward). Notch 76 is provided at a position corresponding to partition portion 442 of second high-density portion 44. By sliding second squeegee 75 on the surface of second electrode slurry 48, a protrusion 49 is formed on a line along which notch 76 passes. The portion where protrusion 49 is formed becomes thick. In this way, a thick film portion is formed to divide a reference film thickness portion into two or more and surround each of the divided reference film thickness portions. The thick film portion is thicker than the reference film thickness portion.

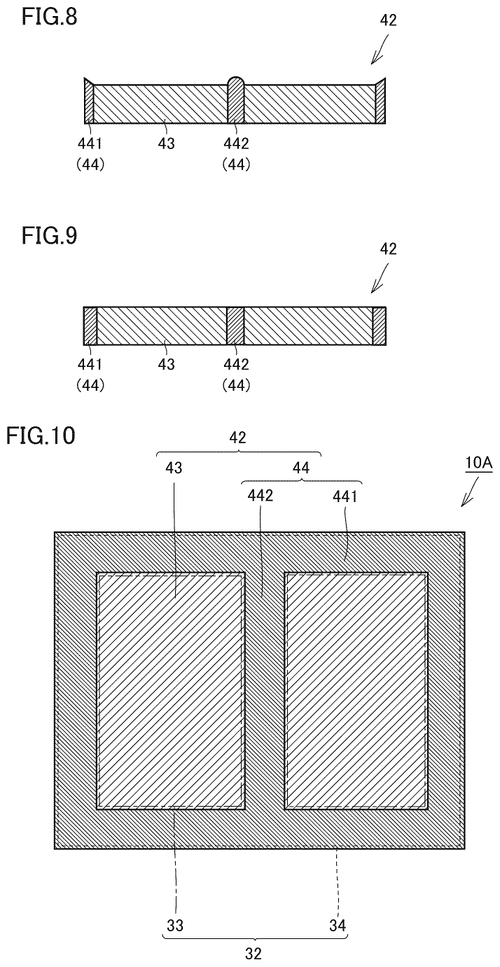

Then, second electrode slurry 48 whose surface shape has been adjusted is pressed. For example, second electrode current collector 41 and second electrode slurry 48 are sandwiched by a pressing device such as a pressure roller. Thereby, second electrode composite material layer 42 is formed as shown in FIG. 8. More specifically, second high-density portion 44 is constituted of: the thick film portion provided on the outer edge portion of second electrode slurry 48; and the thick film portion in the portion where protrusion 49 is formed. Also, second reference density portion 43 is constituted of other portions (the above-described reference film thickness portion) of second electrode slurry 48. In this state, second high-density portion 44 is thicker than second reference density portion 43.

Then, second electrode composite material layer 42 provided with second high-density portion 44 is pressed again. In the same manner as described above, second electrode current collector 41 and second electrode composite material layer 42 are sandwiched by a pressing device such as a pressure roller. Thereby, second high-density portion 44 and second reference density portion 43 are configured to have substantially the same thickness as shown in FIG. 9. Second high-density portion 44 may be thicker than second reference density portion 43. For example, second high-density portion 44 may be thicker than second reference density portion 43 by 1% or more, or by 2% or more. Further, second high-density portion 44 may be thicker than second reference density portion 43 by 3% or more. Second high-density portion 44 thus formed may be higher in density than second reference density portion 43, for example, by 10% or more.

In the same manner as described above, first electrode composite material layer 32 can also be formed by applying the first electrode slurry onto first electrode current collector 31, adjusting the shape of the applied first electrode slurry using the first and second squeegees, and then pressing the resulting slurry twice.

In first electrode composite material layer 32, first high-density portion 34 may be thicker than first reference density portion 33. For example, first high-density portion 34 may be thicker than first reference density portion 33 by 1% or more, or by 2% or more. Further, first high-density portion 34 may be thicker than first reference density portion 33 by 3% or more. First high-density portion 34 thus formed may be higher in density than first reference density portion 33, for example, by 10% or more.

As described above, in power storage cell 1 according to the first embodiment, first high-density portion 34 is provided to divide first reference density portion 33 into two or more and surround each of the two or more first reference density portions 33. Thereby, the electrolyte solution can be suppressed from being pushed out from each of the divided first reference density portions 33 to the outside of first electrode composite material layer 32.

Further, as compared with the configuration in which an outer edge of a single first reference density portion is surrounded by the first high-density portion, it is possible to reduce the distance from first high-density portion 34 surrounding each of divided first reference density portions 33 to the central portion in each of the divided first reference density portions 33. Thus, even when first electrode composite material layer 32 is increased in area, the electrolyte solution pushed out to the outside of first electrode composite material layer 32 easily returns to the central portion in each of the divided first reference density portions 33, so that the liquid retention property can be enhanced.

Further, in second electrode composite material layer 42, second high-density portion 44 is provided to surround second reference density portion 43, and first reference density portion 33 surrounded by first high-density portion 34 is disposed so as to face at least a part of second reference density portion 43 surrounded by second high-density portion 44, with separator 50 being interposed between first reference density portion 33 and the part of second reference density portion 43. Thereby, also on the second electrode composite material layer 42 side, the electrolyte solution can be suppressed from being pushed out to the outside of second electrode composite material layer 42.

Further, as first high-density portion 34 is thicker than first reference density portion 33, the electrolyte solution is less easily discharged to the outside of first electrode composite material layer 32. Similarly, as second high-density portion 44 is thicker than second reference density portion 43, the electrolyte solution is less easily discharged to the outside of second electrode composite material layer 42.

### Second Embodiment

FIG. 10 is a schematic plan view showing the positional relation between a second electrode and a first electrode of a power storage cell according to the second embodiment. The power storage cell according to the second embodiment will be hereinafter described with reference to FIG. 10.

As shown in FIG. 10, the power storage cell according to the second embodiment is different from power storage cell 1 according to the first embodiment in the configuration of an electrode body 10A. Other configurations are substantially the same.

Electrode body 10A is different from electrode body 10 according to the first embodiment in arrangement of first reference density portion 33 and first high-density portion 34, and in arrangement of second reference density portion 43 and second high-density portion 44.

In the present embodiment, frame-shaped portion 441 of second high-density portion 44 is provided in a frame shape along the outer edge of second electrode current collector 41, and partition portion 442 is provided so as to substantially equally divide the region surrounded by frame-shaped portion 441 into two regions. Second reference density portion 43 is disposed in each of the divided two regions. First reference density portion 33 and first high-density portion 34 are substantially identical in shape to second reference density portion 43 and second high-density portion 44, respectively.

When viewed in the stacking direction, each first reference density portion 33 surrounded by first high-density portion 34 coincides with each second reference density portion 43 surrounded by second high-density portion 44. Each first reference density portion 33 surrounded by first high-density portion 34 does not overlap with frame-shaped portion 441, and each second reference density portion 43 surrounded by second high-density portion 44 also does not overlap with frame-shaped portion 341. Further, when viewed in the stacking direction, frame-shaped portion 341 is disposed to overlap with frame-shaped portion 441, and the partition portion of first high-density portion 34 is disposed to overlap with partition portion 442 of second high-density portion 44.

Even in such a configuration, the power storage cell according to the second embodiment achieves substantially the same effect as that achieved by the power storage cell according to the first embodiment. Further, when viewed in the stacking direction, each first reference density portion 33 overlaps with each second reference density portion 43, so that the capacity sustaining effect (capacity retention ratio) can be enhanced while enhancing the liquid retention property in each of first electrode composite material layer 32 and second electrode composite material layer 42.

### Third Embodiment

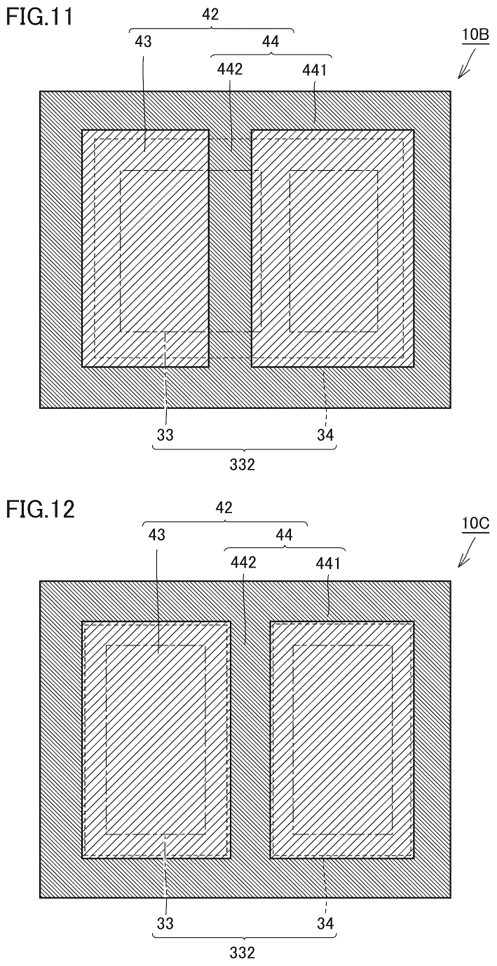

FIG. 11 is a schematic plan view showing the positional relation between a second electrode and a first electrode of a power storage cell according to the third embodiment. The power storage cell according to the third embodiment will be hereinafter described with reference to FIG. 11.

As shown in FIG. 11, the power storage cell according to the third embodiment is different from power storage cell 1 according to the first embodiment in the configuration of an electrode body 10B. Other configurations are substantially the same.

Electrode body 10B is different from electrode body 10 according to the first embodiment in arrangement of first reference density portion 33 and first high-density portion 34, and in arrangement of second reference density portion 43 and second high-density portion 44.

In the present embodiment, frame-shaped portion 441 of second high-density portion 44 is provided in a frame shape along the outer edge of second electrode current collector 41, and partition portion 442 is provided to divide the region surrounded by frame-shaped portion 441 into two regions. The areas of the divided two regions may be different from each other.

When viewed in the stacking direction, frame-shaped portion 341 of first high-density portion 34 is disposed not to overlap with frame-shaped portion 441 of second high-density portion 44, and is disposed inside frame-shaped portion 441 at a prescribed distance from frame-shaped portion 441. When viewed in the stacking direction, partition portion 342 is disposed not to overlap with partition portion 442 and is disposed at a prescribed distance from partition portion 442.

Even in such a configuration, the power storage cell according to the second embodiment achieves substantially the same effect as that achieved by the power storage cell according to the first embodiment.

### Fourth Embodiment

FIG. 12 is a schematic plan view showing the positional relation between a second electrode and a first electrode of a power storage cell according to the fourth embodiment. The power storage cell according to the fourth embodiment will be hereinafter described with reference to FIG. 12.

As shown in FIG. 12, the power storage cell according to the fourth embodiment is different from power storage cell 1 according to the first embodiment in the configuration of an electrode body 10C. Other configurations are substantially the same.

Electrode body 10C is different from electrode body 10 according to the first embodiment in arrangement of first reference density portion 33 and first high-density portion 34, and in arrangement of second reference density portion 43 and second high-density portion 44.

In the present embodiment, frame-shaped portion 441 of second high-density portion 44 is provided in a frame shape along the outer edge of second electrode current collector 41, and partition portion 442 is provided so as to substantially equally divide the region surrounded by frame-shaped portion 441 into two regions. Second reference density portion 43 is disposed in each of the divided two regions.

First high-density portion 34 includes two frame-shaped portions. When viewed in the stacking direction, each of the two frame-shaped portions is disposed in a corresponding one of two frame-shaped portions 441 divided by partition portion 442. First reference density portion 33 is disposed inside each of the two frame-shaped portions. When viewed in the stacking direction, first reference density portion 33 is disposed not to overlap with second high-density portion 44 but to overlap with a part of second reference density portion 43 inside second reference density portion 43.

Even in such a configuration, the power storage cell according to the second embodiment achieves substantially the same effect as that achieved by the power storage cell according to the first embodiment.

### Other Modifications

The first to fourth embodiments have been described above with regard to an example in which the first electrode is a positive electrode, the second electrode is a negative electrode, first electrode composite material layer 32 is a positive electrode composite material layer, and second electrode composite material layer 42 is a negative electrode composite material layer but the present disclosure is not limited thereto. In other words, the first electrode may be a negative electrode, the second electrode may be a positive electrode, first electrode composite material layer 32 may be a negative electrode composite material layer, and second electrode composite material layer 42 may be a positive electrode composite material layer.

The first to fourth embodiments have been described above with regard to an example in which each of first reference density portion 33 and second reference density portion 43 is divided into two regions, but the present disclosure is not limited thereto, and at least one of first reference density portion 33 and second reference density portion 43 should only be divided into two or more. Each of first reference density portion 33 and second reference density portion 43 may be divided into two or more. The number of divided first reference density portions 33 may be the same as or different from the number of divided second reference density portions 43.

### First Verification Experiment

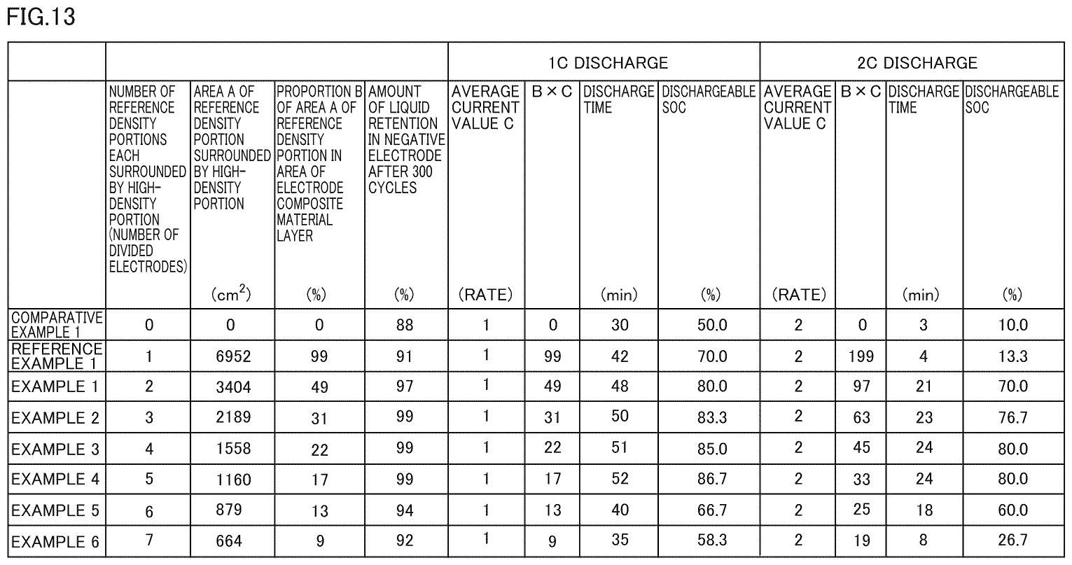

FIG. 13 is a diagram showing conditions and results of the first verification experiment. The first verification experiment will be hereinafter described with reference to FIG. 13.

As shown in FIG. 13, in the first verification experiment, power storage cells according to Comparative Example 1, Reference Example 1, and Examples 1 to 6 were prepared to evaluate the performance of each of the power storage cells. Specifically, at an environmental temperature of 25° C., 300 cycles of charging from SOC 0% to SOC 100% were conducted at a current value of 0.2 C. After 5 cycles of charging at 1 C from SOC 0% to SOC 100%, the SOC was set at 100%. Then, the dischargeable SOC obtained as a result of discharging to a lower limit voltage of 3V was evaluated. Note that the current value during discharging was evaluated at each of 1C and 2C.

The capacity of each power storage cell was 60 Ah. In each power storage cell, the area of a coating on the first electrode composite material layer (the positive electrode composite material layer) was 7000 cm², and the basis weight of the first electrode (the positive electrode) was 30 mg/cm². The area of a coating on the second electrode composite material layer (the negative electrode composite material layer) was 7050 cm², and the basis weight of the second electrode (the negative electrode) was 20 mg/cm².

In the power storage cell according to Comparative Example 1, as shown in FIG. 13, the number of the divided electrodes was zero. Specifically, in the prepared structure, first electrode composite material layer 32 was formed only of first reference density portion 33 and not provided with first high-density portion 34. Similarly, second electrode composite material layer 42 was also formed only of second reference density portion 43 and not provided with second high-density portion 44. In other words, an area A of the reference density portion surrounded by the high-density portion was 0 cm², and a proportion B of area A of the reference density portion in the area of the electrode composite material layer was 0%.

In the power storage cell according to Comparative Example 1, the amount of liquid retention in the negative electrode after 300 cycles was 88%. Further, in the case of discharging at an average current value C of 1 C (1 C discharge), B×C was 0, and the discharge time was 30 minutes. The dischargeable SOC was 50.0%. In the case of discharging at average current value C of 2 C (2 C discharge), B×C was 0 and the discharge time was 3 minutes. The dischargeable SOC was 10.0%.

In the power storage cell according to Reference Example 1, the number of the divided electrodes was one. Specifically, in first electrode composite material layer 32, the outer periphery of first reference density portion 33 was surrounded by first high-density portion 34, and the number of first reference density portions 33 was one. At this time, area A of first reference density portion 33 surrounded by first high-density portion 34 was 6952 cm², and proportion B of area A of first reference density portion 33 in the area of first electrode composite material layer 32 was 99%. Also on the second electrode composite material layer 42 side, substantially the same configuration as that of first electrode composite material layer 32 was provided. In other words, the number of divided second reference density portions 43 was one.

In the power storage cell according to Reference Example 1, the amount of liquid retention in the negative electrode after 300 cycles was 91%. Further, in the case of discharging at average current value C of 1 C (1 C discharge), B×C was 99, and the discharge time was 42 minutes. The dischargeable SOC was 70.0%. In the case of discharging at average current value C of 2 C (2 C discharge), B×C was 199, and the discharge time was 4 minutes. The dischargeable SOC was 13.3%.

In the power storage cell according to Example 1, the number of the divided electrodes was two. Specifically, the power storage cell according to the second embodiment was prepared. At this time, area A of each first reference density portion 33 surrounded by first high-density portion 34 was 3404 cm², and proportion B of area A of each first reference density portion 33 in the area of first electrode composite material layer 32 was 49%. Also on the second electrode composite material layer 42 side, substantially the same configuration as that of first electrode composite material layer 32 was provided. In other words, the number of divided second reference density portions 43 was two.

In the power storage cell according to Example 1, the amount of liquid retention in the negative electrode after 300 cycles was 97%. Further, in the case of discharging at average current value C of 1 C (1 C discharge), B×C was 49, and the discharge time was 48 minutes. The dischargeable SOC was 80.0%. In the case of discharging at average current value C of 2 C (2 C discharge), B×C was 97, and the discharge time was 21 minutes. The dischargeable SOC was 70.0%.

In the power storage cell according to Example 2, the number of the divided electrodes was three. Specifically, the inside of frame-shaped portion 341 of first high-density portion 34 was divided into three regions by two partition portions 342, and first reference density portion 33 was disposed in each of the divided three regions. At this time, area A of each first reference density portion 33 surrounded by first high-density portion 34 was 2189 cm², and proportion B of area A of each first reference density portion 33 in the area of first electrode composite material layer 32 was 31%. Also on the second electrode composite material layer 42 side, substantially the same configuration as that of first electrode composite material layer 32 was provided. In other words, the number of divided second reference density portions 43 was three.

In the power storage cell according to Example 2, the amount of liquid retention in the negative electrode after 300 cycles was 99%. Further, in the case of discharging at average current value C of 1 C (1 C discharge), B×C was 31, and the discharge time was 50 minutes. The dischargeable SOC was 83.3%. In the case of discharging at average current value C of 2 C (2 C discharge), B×C was 63, and the discharge time was 23 minutes. The dischargeable SOC was 76.7%.

In the power storage cell according to Example 3, the number of the divided electrodes was four. Specifically, the inside of frame-shaped portion 341 of first high-density portion 34 was divided into four regions by the plurality of partition portions 342, and first reference density portion 33 was disposed in each of the divided four regions. At this time, area A of each first reference density portion 33 surrounded by first high-density portion 34 was 1558 cm², and proportion B of area A of each first reference density portion 33 in the area of first electrode composite material layer 32 was 22%. Also on the second electrode composite material layer 42 side, substantially the same configuration as that of first electrode composite material layer 32 was provided. In other words, the number of divided second reference density portions 43 was four.

In the power storage cell according to Example 3, the amount of liquid retention in the negative electrode after 300 cycles was 99%. Further, in the case of discharging at average current value C of 1 C (1 C discharge), B×C was 22, and the discharge time was 51 minutes. The dischargeable SOC was 85.0%. In the case of discharging at average current value C of 2 C (2 C discharge), B×C was 45 and the discharge time was 24 minutes. The dischargeable SOC was 80.0%.

In the power storage cell according to Example 4, the number of the divided electrodes was five. Specifically, the inside of frame-shaped portion 341 of first high-density portion 34 was divided into five regions by the plurality of partition portions 342, and first reference density portion 33 was disposed in each of these divided five regions. At this time, area A of each first reference density portion 33 surrounded by first high-density portion 34 was 1160 cm², and proportion B of area A of each first reference density portion 33 in the area of first electrode composite material layer 32 was 17%. Also on the second electrode composite material layer 42 side, substantially the same configuration as that of first electrode composite material layer 32 was provided. In other words, the number of divided second reference density portions 43 was five.

In the power storage cell according to Example 4, the amount of liquid retention in the negative electrode after 300 cycles was 99%. Further, in the case of discharging at average current value C of 1 C (1 C discharge), B×C was 17, and the discharge time was 52 minutes. The dischargeable SOC was 86.7%. In the case of discharging at average current value C of 2 C (2 C discharge), B×C was 33, and the discharge time was 24 minutes. The dischargeable SOC was 80.0%.

In the power storage cell according to Example 5, the number of the divided electrodes was six. Specifically, the inside of frame-shaped portion 341 of first high-density portion 34 was divided into six regions by the plurality of partition portions 342, and first reference density portion 33 was disposed in each of these divided six regions. At this time, area A of each first reference density portion 33 surrounded by first high-density portion 34 was 879 cm², and proportion B of area A of each first reference density portion 33 in the area of first electrode composite material layer 32 was 13%. Also on the second electrode composite material layer 42 side, substantially the same configuration as that of first electrode composite material layer 32 was provided. In other words, the number of divided second reference density portions 43 was six.

In the power storage cell according to Example 5, the amount of liquid retention in the negative electrode after 300 cycles was 94%. Further, in the case of discharging at average current value C of 1 C (1 C discharge), B×C was 13, and the discharge time was 40 minutes. The dischargeable SOC was 66.7%. In the case of discharging at average current value C of 2 C (2 C discharge), B×C was 25, and the discharge time was 18 minutes. The dischargeable SOC was 60.0%.

In the power storage cell according to Example 6, the number of the divided electrodes was seven. Specifically, the inside of frame-shaped portion 341 of first high-density portion 34 was divided into seven regions by the plurality of partition portions 342, and first reference density portion 33 was disposed in each of these divided seven regions. At this time, area A of each first reference density portion 33 surrounded by first high-density portion 34 was 664 cm², and proportion B of area A of each first reference density portion 33 in the area of first electrode composite material layer 32 was 9%. Also on the second electrode composite material layer 42 side, substantially the same configuration as that of first electrode composite material layer 32 was provided. In other words, the number of divided second reference density portions 43 was seven.

In the power storage cell according to Example 5, the amount of liquid retention in the negative electrode after 300 cycles was 92%. Further, in the case of discharging at average current value C of 1 C (1 C discharge), B×C was 9, and the discharge time was 35 minutes. The dischargeable SOC was 58.3%. In the case of discharging at average current value C of 2 C (2 C discharge), B×C was 19, and the discharge time was 8 minutes. The dischargeable SOC was 26.7%.

The power storage cell according to Reference Example 1 was improved as compared with the power storage cell according to Comparative Example 1 in terms of the amount of liquid retention in the negative electrode after 300 cycles, the dischargeable SOC in 1 C discharge, and the dischargeable SOC in 2 C discharge.

The power storage cells according to Examples 1 to 5 were improved as compared with the power storage cell according to Comparative Example 1 in terms of the amount of liquid retention in the negative electrode after 300 cycles, the dischargeable SOC in 1 C discharge, and the dischargeable SOC in 2 C discharge.

The power storage cells according to Examples 1 to 4 were improved as compared with the power storage cell according to Reference Example 1 in terms of the amount of liquid retention in the negative electrode after 300 cycles, the dischargeable SOC in 1 C discharge, and the dischargeable SOC in 2 C discharge.

As compared with the power storage cell according to Reference Example 1, the power storage cells according to Examples 5 and 6 were slightly decreased in dischargeable SOC in 1 C discharge but improved in the amount of liquid retention in the negative electrode after 300 cycles and the dischargeable SOC in 2 C discharge.

Based on the results as described above, it was confirmed that each of Examples 1 to 6 in which the number of divided electrodes was two or more could be improved as compared with Reference Example 1 in terms of the amount of liquid retention in the negative electrode after 300 cycles (i.e., improved in liquid retention property), and also, in terms of the dischargeable SOC in 2 C discharge. Further, the same effect as described above was confirmed when the area of each of first reference density portions 33 divided by first high-density portion 34 was 600 cm² or more and less than 6952 cm² (more specifically, 6900 cm² or less).

Further, it was confirmed that the capacity sustaining effect could be enhanced by satisfying the relation of 9≤B×C<199 where B (%) represents the proportion of the area of first reference density portion 33 surrounded by first high-density portion 34 in the area of first electrode composite material layer 32, and C represents the average discharge rate during discharging. More specifically, it was confirmed that the capacity sustaining effect could be further enhanced by satisfying the relation of 9≤B×C≤115, and further, 9≤B×C<99, and 9≤B×C≤97. In the above description, the value of 115 based on the expression “B×C” was calculated as a value at which the dischargeable SOC was about 60% when Reference Example 1 and Example 1 were plotted and connected by a straight line on the coordinates where the horizontal axis represents B×C and the vertical axis represents the dischargeable SOC in 2 C discharge. Further, it was confirmed that the capacity sustaining effect could be further enhanced when the relation between the B and the C satisfies 17≤B×C<99, more specifically 17≤B×C≤63.

### Second Verification Experiment

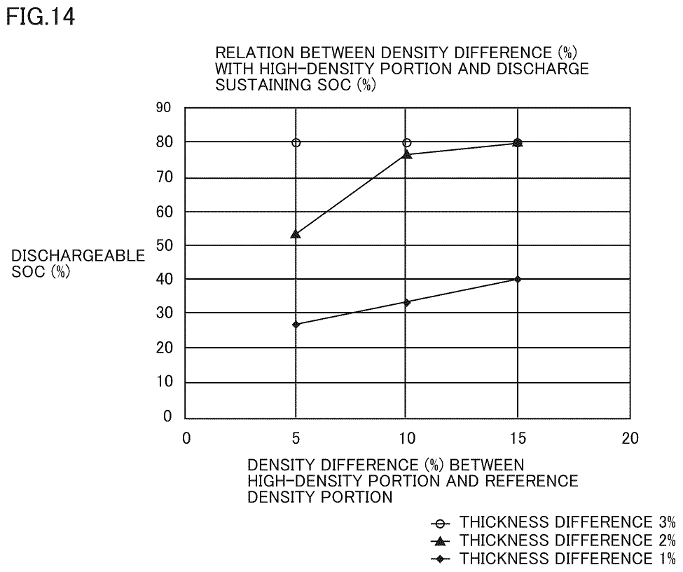

FIG. 14 is a diagram showing conditions and results of the second verification experiment. The second verification experiment will be hereinafter described with reference to FIG. 14.

In the second verification experiment, a power storage cell for which the number of divided electrodes was three was used as in Example 2. In the second verification experiment, the relation between: the dischargeable SOC (%) at 2 C and the density difference (%) between the first high-density portion and the first reference density portion was examined under substantially the same conditions as those in the first verification experiment except that the thickness difference between the first high-density portion and the first reference density portion was changed. Note that the first high-density portion was thicker than the first reference density portion. The relation between the second high-density portion and the second reference density portion was also the same as the relation between the first high-density portion and the first reference density portion.

In the case where the thickness difference between the first high-density portion and the first reference density portion was 3%, a significant difference was not observed when the density difference between the first high-density portion and the first reference density portion was 5%, 10%, or 15%. In each of the cases, the dischargeable SOC was about 80%.

In the case where the thickness difference between the first high-density portion and the first reference density portion was 2%, the density difference between the first high-density portion and the first reference density portion increased from 5% to 15%, and thereby, the dischargeable SOC increased accordingly. In the case where the density difference between the first high-density portion and the first reference density portion was 5%, the dischargeable SOC was about 53%. However, in the case where the density difference between the first high-density portion and the first reference density portion was 10%, the dischargeable SOC was about 78%. In the case where the density difference between the first high-density portion and the first reference density portion was 15%, the dischargeable SOC was about 80%.

In the case where the thickness difference between the first high-density portion and the first reference density portion was 1%, the density difference between the first high-density portion and the first reference density portion increased from 5% to 15%, and thereby, the dischargeable SOC increased accordingly. In the case where the density difference between the first high-density portion and the first reference density portion was 5%, the dischargeable SOC was about 27%. In the case where the density difference between the first high-density portion and the first reference density portion was 10%, the dischargeable SOC was about 33%. In the case where the density difference between the first high-density portion and the first reference density portion was 15%, the dischargeable SOC was about 40%.

Based on the experiments as described above, it was confirmed that the dischargeable SOC was improved when the first high-density portion was thicker than the first reference density portion, and also when the density difference between the first high-density portion and the first reference density portion was 10% or more. Further, it was confirmed that the dischargeable SOC could be more effectively improved when the first high-density portion was higher in density than the first reference density portion by 10% or more and the high-density portion was thicker than the reference density portion by 2% or more. The same also applies to the relation between the second high-density portion and the second reference density portion.

The power storage cells according to the first to fourth embodiments and the power storage cells according to Examples 1 to 6 can also be applied to a bipolar battery having a positive electrode composite material layer and a negative electrode composite material layer on both sides of a current collector.

Although the embodiments of the present disclosure have been described, it should be understood that the embodiments disclosed herein are illustrative and not restrictive in every respect. The scope of the present disclosure is defined by the terms of the claims, and is intended to include any modifications within the meaning and scope equivalent to the terms of the claims.

What is claimed is:

1. A power storage cell in which an electrolyte solution is used, the power storage cell comprising:
a first electrode composite material layer;
a separator; and
a second electrode composite material layer facing the first electrode composite material layer with the separator interposed therebetween, wherein
the first electrode composite material layer includes
a first reference density portion, and
a first high-density portion higher in density than the first reference density portion, and
the first high-density portion is provided to divide the first reference density portion into two or more and surround each of the first reference density portions.

2. The power storage cell according to claim 1, wherein
the second electrode composite material layer includes
a second reference density portion, and
a second high-density portion higher in density than the second reference density portion,
the second high-density portion is provided to surround the second reference density portion, and
the first reference density portion surrounded by the first high-density portion is disposed to face at least a part of the second reference density portion surrounded by the second high-density portion, with the separator being interposed between the first reference density portion and the part of the second reference density portion.

3. The power storage cell according to claim 2, wherein
the second high-density portion is provided to divide the second reference density portion into two or more and surround each of the second reference density portions, and
when viewed in a stacking direction in which the first electrode composite material layer and the second electrode composite material layer are stacked, each of the first reference density portions each surrounded by the first high-density portion overlaps with each of the second reference density portions each surrounded by the second high-density portion.

4. The power storage cell according to claim 1, wherein the first high-density portion is higher in density than the first reference density portion by 10% or more.

5. The power storage cell according to claim 1, wherein a relation of 9≤B×C<199 is satisfied, where B (%) represents a proportion of an area of the first reference density portion surrounded by the first high-density portion in an area of the first electrode composite material layer, and C represents an average discharge rate during discharging.

6. The power storage cell according to claim 5, wherein a relation between the B and the C satisfies 17≤B×C<99.

7. The power storage cell according to claim 1, wherein the first high-density portion is thicker than the first reference density portion.

8. The power storage cell according to claim 1, wherein each of the first reference density portions divided by the first high-density portion has an area of 600 cm² or more.

9. A method of manufacturing an electrode composite material layer, the method comprising:
disposing a frame member on a current collector and coating an inside of the frame member with an electrode slurry;
forming a reference film thickness portion and a thick film portion thicker than the reference film thickness portion on the electrode slurry applied by the coating; and
pressing the electrode slurry on which the thick film portion is formed, wherein
in the forming a thick film portion, the thick film portion is formed to divide the reference film thickness portion into two or more and surround each of the reference film thickness portions, and
in the pressing, a reference density portion is formed in a portion where the reference film thickness portion is formed, and a high-density portion higher in density than the reference density portion is formed in a portion where the thick film portion is formed.
